(19) United States
(12) Patent Application Publication
(10) Pub. No.: US 2012/0094709 A1
(43) Pub. Date: Apr. 19, 2012

(54) WIRELESS TRANSMISSION APPARATUS AND TRANSMISSION POWER CONTROL METHOD

(75) Inventors: Yoshihiko Ogawa, Kanagawa (JP); Kenichi Miyoshi, Kanagawa (JP); Akihiko Nishio, Kanagawa (JP); Daichi Imamura, Kanagawa (JP); Seigo Nakao, Kanagawa (JP)

(73) Assignee: Panasonic Corporation, Osaka (JP)

(21) Appl. No.: 13/375,386

(22) PCT Filed: Jun. 17, 2010
(86) PCT No.: PCT/JP2010/004053

§ 371 Date: Nov. 30, 2011

(30) Foreign Application Priority Data
Jun. 18, 2009 (JP) 2009-145534

(51) Int. Cl. H04W 52/04

(52) U.S. Cl. 455/522

(57) ABSTRACT

Disclosed are a wireless transmission apparatus and transmission power control method which improve the error rate characteristics of data signals even when the number of streams of data signals increases, without increasing the amount of signaling. The relationship between the number of streams of data signals in each antenna (201-1, 201-2) and the data signal and pilot-signal transmission power ratio at each antenna (201-1,201-2) is stored. Specifically, a relationship where the data signal and pilot signal transmission power ratio at each antenna increases as the number of streams of data signals at each antenna increases is stored. A transmission power control unit (205) determines the data signal and pilot signal transmission power ratio on the basis of the information of the number of streams of data signals at each antenna (201-1, 201-2) that were output from a decoding unit (204), controls the transmission power of the pilot signals on the basis of the determined transmission power ratio, and outputs to a multiplexing unit (210).

### TECHNICAL FIELD

The present invention relates to a radio transmission apparatus and a transmission power control method.

### BACKGROUND ART

With mobile communication (for example, long term evolution-advanced (LTE-A)), studies of multiple input multiple output (MIMO) transmission of a data signal are underway. With MIMO transmission, studies are underway to perform weight control (precoding) to a data signal and not to perform the weight control to a pilot signal. That is, a data signal is transmitted by multiplexing a plurality of streams at 1 antenna port, and a pilot signal is transmitted without multiplexing a plurality of streams at 1 antenna port. Here, while the number of streams is the number of signals spatially multiplexed, at each antenna shown in FIG. 1, a data signal is transmitted by a plurality of streams, and a pilot signal is transmitted by one stream.

Here, an antenna port means a logical antenna (antenna group) formed by one or multiple physical antennas. Thus, an antenna port is not limited to mean one physical antenna, and may be for example an array antenna formed by multiple antennas. For example, in non-patent literature 1, although how many physical antennas constitute an antenna port is not defined, an antenna port is defined as a minimum unit whereby a radio communication base station apparatus (hereinafter simply referred to as “base station”) can transmit a different reference signal. An antennal port is also defined as a minimum unit of multiplying precoding vector weight.

For ease of explanation, a case will be described below where an “antenna port” and a physical antenna are associated on a one-by-one basis.

Also, since a pilot signal uses an orthogonal sequence, ideally, it is possible to demultiplex sequences without generating inter-sequence interference. However, there is for example a delayed wave in an actual environment, so that a quantity of inter-sequence interference is generated.

As shown in FIG. 2, non-patent literature 1 employs a method to make transmission power of a data signal and transmission power of a pilot signal be the same (which is known in advance at transmission/reception sides). In this method, the difference between the transmission power of a data signal and the transmission power of a pilot signal is known at transmission/reception sides, so that it is possible to perform accurate channel estimation corresponding to m-ary modulation. By controlling transmission power of a data signal only, it is also possible to control transmission power of a pilot signal, so that it is possible to decrease the amount of signaling.

### CITATION LIST

### Non-Patent Literature

### NPL 1

5.5.2.1.2 Mapping to physical resources, TS36.211 v8.5.0 “3GPP TSG RAN; Evolved Universal Terrestrial Radio Access (E-UTRA); Physical Channel and Modulation”

### SUMMARY OF INVENTION

### Technical Problem

However, when a pilot signal has the same transmission power as a data signal, as the number of data signal streams increases, a block error rate (BLER) characteristic of a data signal is deteriorated. This is because after demultiplexing streams at a receiver, streams (interference components) other than a desired stream remain in a desired stream, so that as the number of streams increases, the number of streams of interference components increases. In other words, an interference component (I component) of a signal-to-interference and noise power ratio (SINR) is an interference component from streams other than the desired wave, and since this interference component enlarges as the number of streams increases, channel estimation result includes an error.

On the other hand, if transmission power of a data signal and transmission power of a pilot signal are controlled individually, by controlling transmission power of a pilot signal and enhancing channel estimation accuracy, it is possible to improve a BLER characteristic of a data signal, but the requirement to control both transmission power of a data signal and a pilot signal results in increase of the amount of signaling.

It is therefore an object of the present invention to provide a radio transmission apparatus and transmission power control method to improve an error rate characteristic of a data signal without increasing the amount of signaling, even if the number of data signal streams increases.

### Solution to Problem

The radio transmission apparatus of the present invention employs a configuration having: one or more antennas; a transmission power control section that increases a transmission power ratio of a pilot signal to a data signal transmitted from each of the antennas, in response to an increase in the number of streams of the data signal transmitted from each of the antennas; and a transmission section that transmits the data signal and the pilot signal for which transmission power is controlled.

The transmission power control method of the present invention increases a transmission power ratio of a pilot signal to a data signal from one or more antennas, in response to an increase in the number of streams of the data signal transmitted from each of the antennas.

### Advantageous Effects of Invention

According to the present invention, even if the number of data signal streams increases, it is possible to improve an error rate characteristic of a data signal without increasing the amount of signaling.

### BRIEF DESCRIPTION OF DRAWINGS

FIG. 1 shows weight control to a data signal in MIMO transmission;

FIG. 2 shows a method disclosed in non-patent literature 1 of making transmission power of a data signal and transmission power of a pilot signal be the same;

FIG. 3 is a block diagram showing a configuration of a base station according to embodiment 1 of the present invention;

FIG. 4 is a block diagram showing a configuration of a terminal according to embodiment 1 of the present invention;

FIG. 5 shows the relationship between the number of streams and the transmission power ratio according to embodiment 1 of the present invention;

FIG. 6 shows other relationship between the number of streams and the transmission power ratio according to embodiment 1 of the present invention;

FIG. 7 shows other relationship between the number of streams and the transmission power ratio according to embodiment 1 of the present invention;

FIG. 8 shows how a pilot signal is amplified in a non-linear region;

FIG. 9 shows a relationship between peak power and the number of streams at antennas;

FIG. 10 shows the relationship between the number of streams and the transmission power ratio according to embodiment 2 of the present invention;

FIG. 11 shows the relationship between the number of streams and the transmission power ratio according to embodiment 3 of the present invention; and

FIG. 12 shows the relationship between a modulation scheme and the transmission power ratio according to embodiment 4 of the present invention.

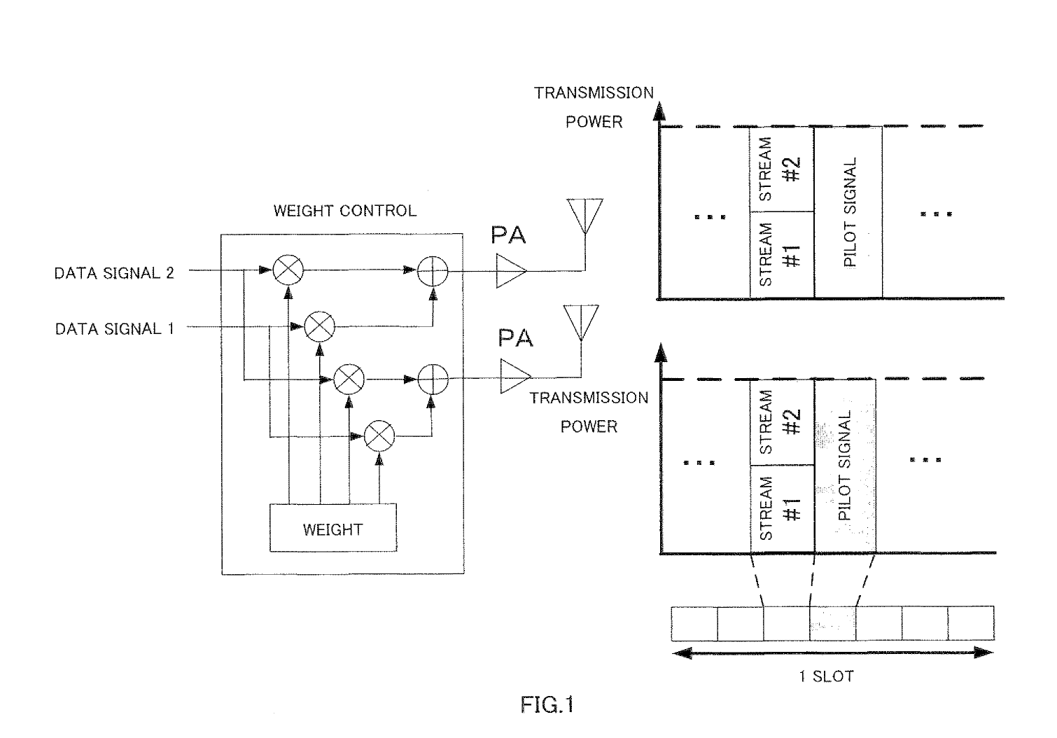

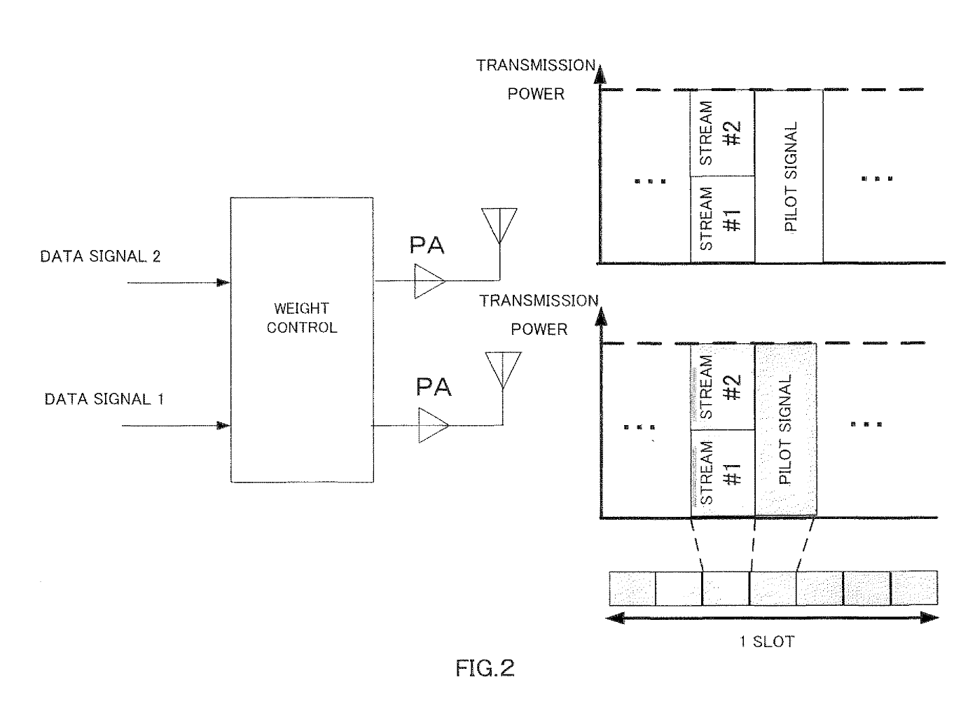

### DESCRIPTION OF EMBODIMENTS

Embodiments of the present invention will be described in detail with reference to the accompanying drawings.

### Embodiment 1

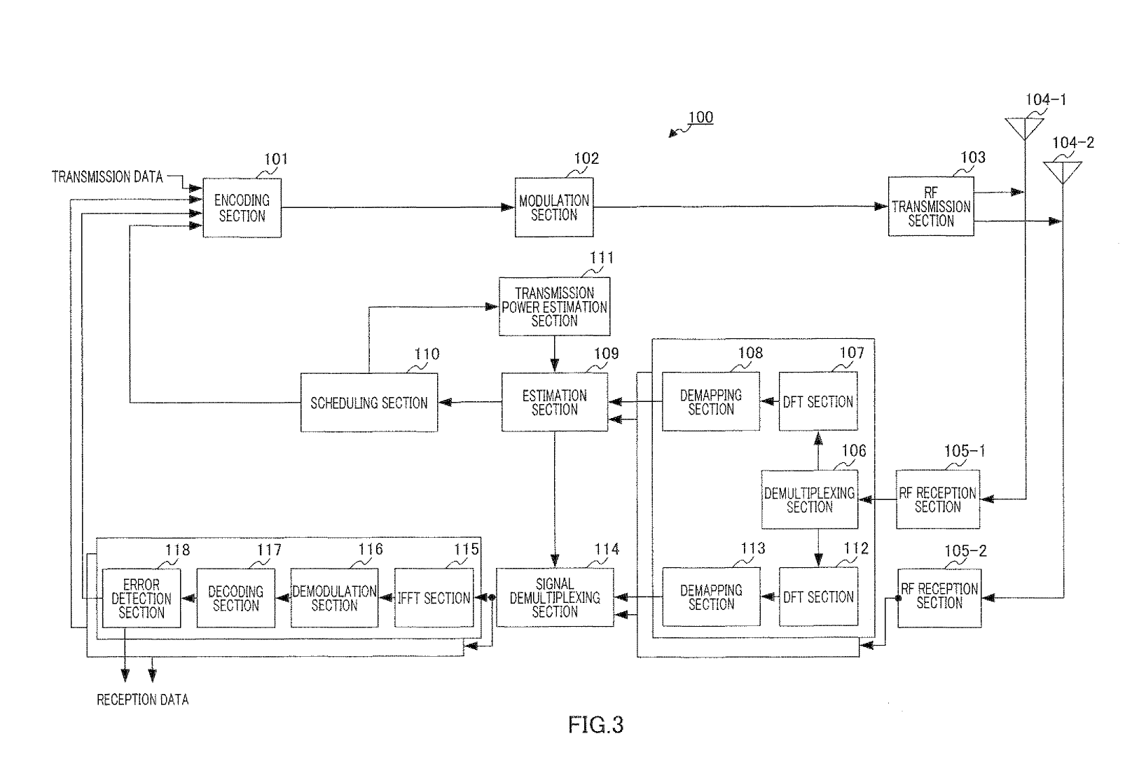

FIG. 3 is a block diagram showing a configuration of base station 100 of embodiment 1 of the present invention. In this figure, transmission data (downlink data), a response signal (ACK signal or NACK signal) output from error detection section 118, resource assignment information of radio communication terminal apparatuses (hereinafter simply referred to as “terminals”), the information output from scheduling section 110, and control information showing for example MCS are input to encoding section 101. Assignment control information is formed by the response signal, the resource assignment information, and the control information. Encoding section 101 encodes transmission data and the assignment control information, and outputs the encoded data to modulation section 102.

Modulation section 102 modulates the encoded data output from encoding section 101 and outputs the result to RF transmission section 103, and RF transmission section 103 performs transmission processing, such as, D/A conversion, up-conversion, and amplification to the signal output from modulation section 102 and transmits by radio the signal to which transmission processing is performed from one or more antennas 104-1 and 104-2, to each terminal.

RF reception sections 105-1 and 105-2 perform reception processing such as down-convert and A/D conversion to signals from each terminal, the signals received through antennas 104-1 and 104-2 and outputs the signal to which reception processing is performed to demultiplexing section 106.

Demultiplexing section 106 demultiplexes signals output from RF reception section 105-1 into a pilot signal and a data signal, outputs the pilot signal to discrete Fourier transform (DFT) section 107, and outputs the data signal to DFT section 112.

DFT section 107 performs DFT processing to a pilot signal output from demultiplexing section 106, and converts a time domain signal into a frequency domain signal. A pilot signal converted into a frequency domain is output to demapping section 108.

From a pilot signal of a frequency domain output from DFT section 107, demapping section 108 extracts a pilot signal in a part corresponding to a transmission band of each terminal, and outputs each extracted pilot signal to estimation section 109.

Based on the transmission power ratio of a pilot signal to a data signal, the ratio output from transmission power estimation section 111 described later, and a pilot signal output from demapping section 108, estimation section 109 estimates frequency fluctuation of a channel (frequency response of a channel) and reception quality. Estimation section 109 outputs the estimated value of frequency fluctuation of the channel to signal demultiplexing section 114, and outputs the estimated value of reception quality to scheduling section 110.

According to the estimated value of reception quality output from estimation section 109, scheduling section 110 schedules assignment to a transmission band (frequency resource) of a transmission signal which each terminal transmits, outputs to encoding section 101 assignment control information (for example, resource assignment information and control information) showing the scheduling result, and outputs resource assignment information (information related to the number of streams of data signals multiplexed at 1 antenna) to transmission power estimation section 111.

Transmission power estimation section 111 stores the relationship between the number of streams of data signals transmitted from each antenna of terminals and the transmission power ratio of a pilot signal to a data signal, a pilot signal and data signal transmitted from each antenna, and decides the transmission power ratio of a pilot signal to a data signal, from the number of streams of data signals of each antenna of terminals, the number of streams output from scheduling section 110. The transmission power ratio of the decided pilot signal is output to estimation section 109. The relationship between the number of data signal streams at each antenna and the transmission power ratio of a pilot signal to a data signal at each antenna is known at both base station 100 and terminal 200.

Meanwhile, DFT section 112 performs DFT processing to a data signal output from demultiplexing section 106, and converts a time domain signal into a frequency domain signal. The data signal converted into a frequency domain is output to demapping section 113.

From a frequency-domain data signal output from DFT section 112, demapping section 113 extracts a data signal in a part corresponding to transmission bands of each terminal, and outputs each extracted data signal to signal demultiplexing section 114.

By using the estimated value of frequency fluctuation of the channel, the estimated value output from estimation section 109 and, applying weight to the data signals output from demapping section 113, and combining the result, signal demultiplexing section 114 demultiplexes the data signals into signals of each layer. The demultiplexed signal is output to inverse fast Fourier transform (IFFT) section 115.

IFFT section 115 performs IFFT processing to a data signal output from signal demultiplexing section 114 and outputs the signal to which IFFT processing is performed to demodulation section 116, and demodulation section 116 performs demodulation processing to a signal output from IFFT section 115 and outputs the signal to which demodulation processing is performed to decoding section 117.

Decoding section 117 performs decoding processing to a signal output from demodulation section 116 and outputs the signal (decoded bit sequence) performed the decoding processing to error detection section 118, and error detection section 118 performs error detection to the decoded bit sequence output from decoding section 117. For example, error detection section 118 performs error detection by using CRC. As a result of error detection, error detection section 118 generates a NACK signal as a response signal when there is an error in a decoded bit, and generates an ACK signal as a response signal when there is no error in a decoded bit. The generated response signal is output to encoding section 101. Also, when there is no error in a decoded bit, a data signal is output as reception data.

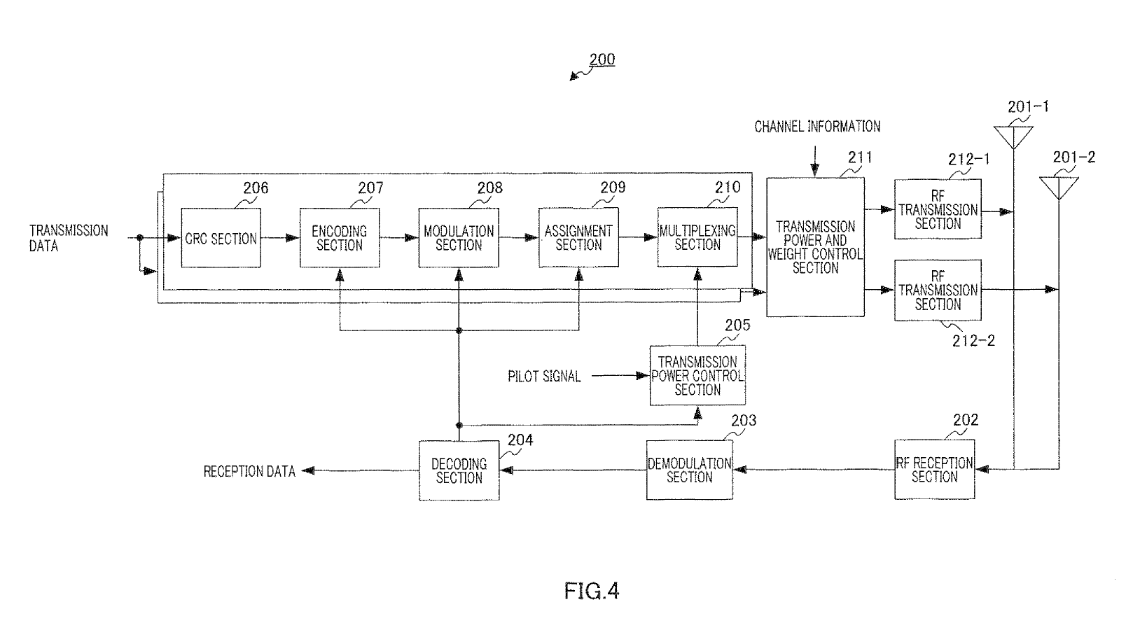

FIG. 4 is a block diagram showing the configuration of terminal 200 according to embodiment 1 of the present invention. In this figure, RF reception section 202 performs reception processing such as down-convert and A/D conversion to signals from base station 100, the signals received through antennas 201-1 and 201-2, and outputs the signal to which reception processing is performed to demodulation section 203.

Demodulation section 203 performs equalization processing and demodulation processing to a signal output from RF reception section 202, and outputs the signal to which these pieces of processing is performed to decoding section 204.

Decoding section 204 performs decoding processing to a signal output from demodulation section 203 and extracts reception data and control information. Here, in the control information, a response signal (ACK signal or NACK signal), resource assignment information (which includes the information related to the number of streams of data signals multiplexed at 1 antenna), and control information are included. In the extracted control information, decoding section 204 outputs resource assignment information and control information to encoding section 207, modulation section 208, and assignment section 209, and outputs resource assignment information to transmission power control section 205.

Transmission power control section 205 stores the relationship between the number of streams of data signals transmitted from each of antennas 201-1 and 201-2 and the transmission power ratio of a pilot signal to a data signal, a pilot signal and data signal transmitted from each of antennas 201-1 and 201-2, and decides the transmission power ratio of a pilot signal to a data signal based on the information of the number of streams of data signals at each of antennas 201-1 and 201-2, the information output from decoding section 204. Based on the decided transmission power ratio, transmission power control section 205 controls transmission power of a pilot signal, and outputs the result to multiplexing section 210. The relationship between the number of stream of a data signal at each of antennas 201-1 and 201-2 and the transmission power ratio of a data signal to a pilot signal at each of antennas 201-1 and 201-2 is known at both base station 100 and terminal 200.

CRC section 206 receives as input separated transmission data, performs CRC encoding to the input transmission data, and generates CRC encoded data. The generated CRC encoded data is output to encoding section 207.

By using control information output from decoding section 204, encoding section 207 encodes the CRC encoded data output from CRC section 206, and outputs the encoded data to modulation section 208.

By using control information output from decoding section 204, modulation section 208 modulates the encoded data output from encoding section 207, and outputs the modulated data signal to assignment section 209.

Based on the resource assignment information output from decoding section 204, assignment section 209 assigns the data signal output from modulation section 208 to a frequency resource (RB). Assignment section 209 outputs the data signal assigned to RB, to multiplexing section 210.

Multiplexing section 210 time-multiplexes a pilot signal output from transmission power control section 205 and a data signal output from assignment section 209, and outputs the multiplex signal to transmission power and weight control section 211; and transmission power and weight control section 211 multiplies the transmission power and weight decided based on channel information to each multiplex signal output from multiplexing section 210, and outputs the generated signal to RF transmission sections 212-1 and 212-2.

RF transmission sections 212-1 and 212-2 performs transmission processing such as D/A conversion, up-conversion, and amplification to the multiplex signal output from transmission power and weight control section 211, and transmits by radio the signal to which transmission processing is performed from antennas 201-1 and 201-2 to base station 100.

Next, the following will describe the relationship between the number of data signal streams at each antenna and the transmission power ratio of a pilot signal to a data signal at each antenna, which is the information the above-described transmission power estimation section 111 and transmission power control section 205 store.

First, the present inventors focus on the following point. Thus, since the increase of the number of data signal streams results in the increase of an interference component, it is necessary to decrease an interference component as the number of streams increases.

Also, when channel estimation accuracy is improved for example by increasing transmission power of a pilot signal, demultiplexing performance of a stream increases, so that it is possible to decrease an interference component remaining in a desired stream. Here, the demultiplexing performance is the performance to demultiplex a desired stream from other streams, and if the demultiplexing performance is high, it is possible to extract the desired stream at low inter-stream interference.

Since a pilot signal uses a sequence having a low cross-correlation, even if the transmission power of a pilot signal increases, it is possible to keep the increase of inter-sequence interference low.

Therefore, in transmission power estimation section 111 and transmission power control section 205, the present inventors make the transmission power ratio of a pilot signal to a data signal at each antenna increase, as the number of data signal streams at each antenna increases. For example, as shown in FIG. 5, when the numbers of data signal streams in an antenna are 1, 2, 3, . . . , the transmission power ratios of data signals to pilot signals are 0 dB, 3 dB, 6 dB, respectively. By this means, as the number of streams increases by one, the transmission power ratio increases by 3 dB.

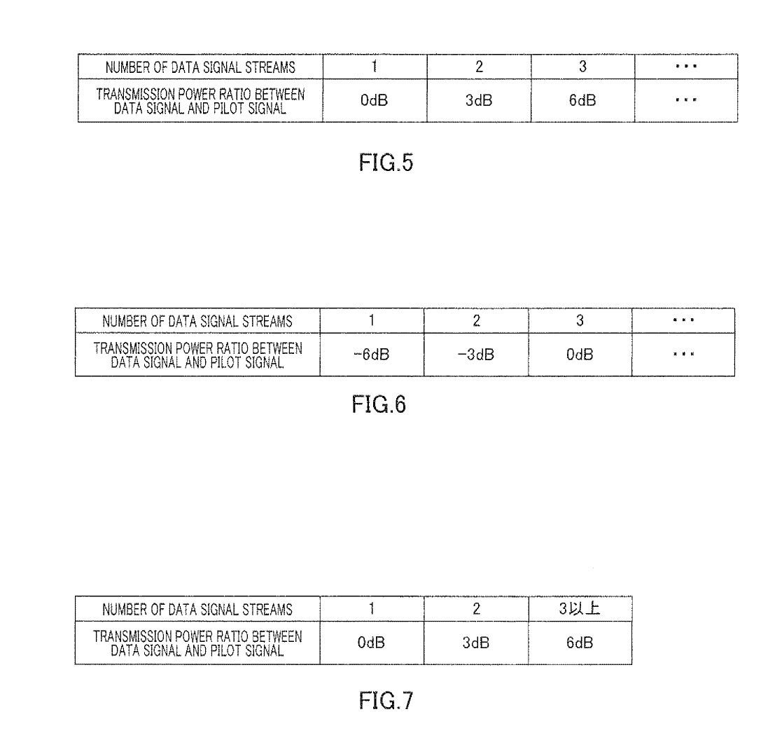

Although case where transmission power of a pilot signal is larger than transmission power of a data signal has been assumed, as shown in FIG. 6, a case where the transmission power of a pilot signal is smaller than transmission power of a data signal is equally possible.

According to embodiment 1, by increasing the transmission power ratio of a pilot signal to a data signal at each antenna as the number of data signal streams at each antenna increases, it is possible to improve channel estimation accuracy even if the number of streams increases, and it is possible to improve a BLER characteristic of a data signal. Also, by providing the transmission power ratio in advance, there is no need to control a data signal and a pilot signal individually, so that it is possible to prevent the amount of signaling from increasing.

When the number of data signal streams at each antenna is equal to or greater than the predetermined value X, it is equally possible to make the transmission power ratios of data signals to pilot signals be fixed. For example, as shown in FIG. 7, when separating the numbers of data signal streams in an antenna into three groups, such as 1, 2, and 3 or more, the transmission power ratios are 0 dB and 3 dB respectively when the numbers of streams are 1 and 2, and the transmission power ratio is fixed as 6 dB when the numbers of stream is 3 or more.

In the above, a characteristic is used where when the number of streams is relatively small, the amount of an interference component remaining in a desired stream increases significantly if the number of streams increases, and when the number of streams is relatively large, the amount of an interference component remaining in a desired stream does not increase even if the number of streams increases. Thus, although when the number of streams is relatively small it is necessary to improve channel estimation accuracy as the number of streams increases, when the number of streams is relatively large there is no need to improve the channel estimation accuracy even if the number of streams increases.

By this means, even if the number of streams increases, it is possible to prevent the amount of memory and the circuit scale that stores the transmission power ratio from increasing.

### Embodiment 2

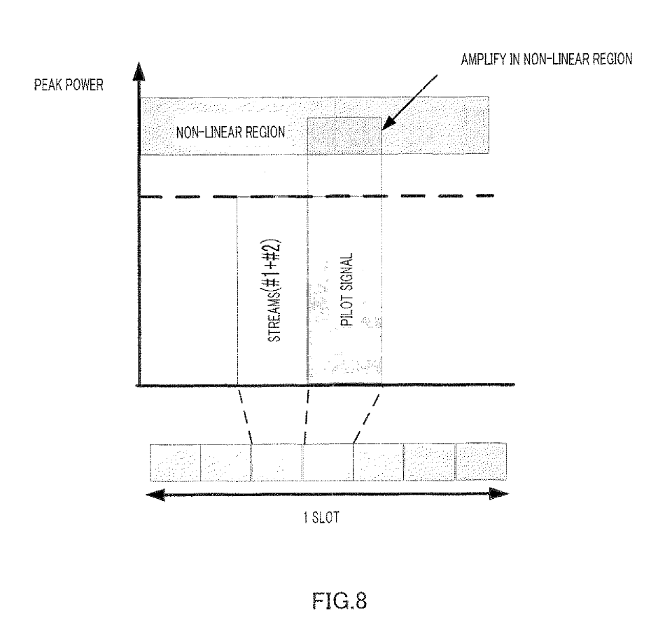

As described in embodiment 1, when the average transmission power of a pilot signal with respect to the average transmission power of a data signal, the transmission power of a pilot signal increases than the transmission power of a data signal. Therefore, as shown in FIG. 8, when a data signal is amplified in a linear region, a pilot signal is amplified in a non-linear region. In this case, a transmitter transmits a pilot signal where distortion is generated due to amplification of a non-linear region, and by this means, at a receiver, channel estimation accuracy is deteriorated due to the distortion of the pilot signal. As a result, the BLER characteristic of the data signal decreases.

Therefore, embodiment 2 of the present invention will describe a method to prevent a pilot signal from being amplified in a non-linear region.

However, since the configuration of a base station according to embodiment 2 of the present invention is the same as the configuration of embodiment 1 shown in FIG. 3 and the only difference is the function of transmission power estimation section 111, only transmission power estimation section 111 will be explained quoting FIG. 3. Also, since the configuration of a terminal according to embodiment 2 of the present invention is the same as the configuration of embodiment 1 shown in FIG. 4 and the only difference is the function of transmission power control section 205, only transmission power control section 205 will be explained quoting FIG. 4.

Since a data signal is amplified in a linear region by transmission power control (peak power of a data signal is not included in a non-linear region), by providing peak power of a pilot signal lower than the peak power of a data signal, it is also possible to amplify the pilot signal in a linear region and to suppress distortion of the pilot signal. Here, a method of limiting the transmission power ratio will be explained based on this characteristic of the peak power in a data signal.

Here, a case is assumed where the average transmission power of data signals after multiplexing streams is fixed regardless of the number of streams. That is, as for a data signal where the number of stream is 1, a data signal where the number of streams is 2 and stream 1 and stream 2 are multiplexed, and a data signal where the number of streams is 3 and streams 1 to 3 are multiplexed, assume that they have the same average transmission power.

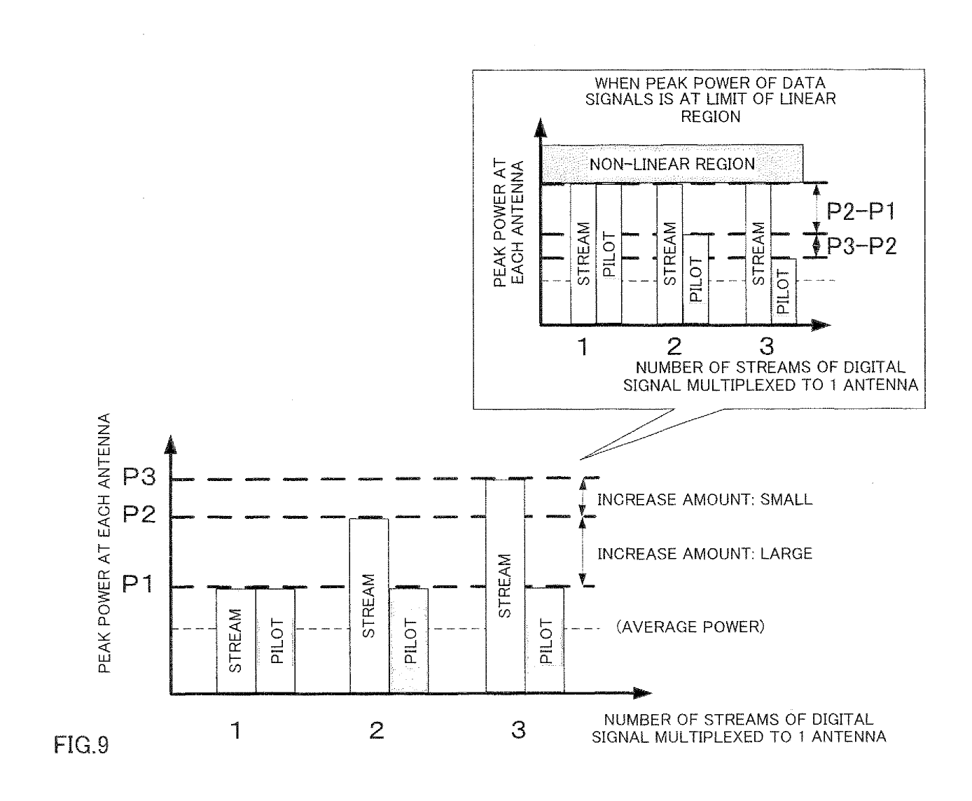

Here, when assuming single carrier transmission of LTE uplink, as the number of data signal streams at each antenna increases, the peak power with respect to the average value of data signals increases. Also, this increase amount of the peak power decreases, as the number of data signal streams at each antenna increases (see FIG. 9).

For example, assume that the average transmission power of data signals is fixed regardless of the number of streams of data signals multiplexed at each antenna, and that the peak powers of the numbers of data signal streams 1 to 3 in an antenna are P1, P2, and P3 respectively. In the peak power of a pilot signal, only one stream is multiplexed, so that the peak power of the pilot signal is fixed regardless of the numbers of data signal streams 1 to 3. In this case, when showing the relationship between “P2-P1,” that is the difference (increase amount) between the peak power of a data signal of the number of stream 1 and the peak power of a data signal of the number of streams 2, and “P3-P2,” that is the difference (increase amount) between the peak power of a data signal of the number of streams 2 and the peak power of a data signal of the number of streams 3, is as follows: “P2-P1>P3-P2,” so that the increase amount decreases as the number of streams increases.

Next, a case to increase transmission power to the maximum with which a data signal can perform transmission in a linear region. In this case, although it is possible to transmit a pilot signal at the limit of a linear region in the number of data signal stream 1, pilot signals are transmitted remaining margins, such as P2-P1 and P3-P1, from the limit of a linear region in the numbers of data signal streams 2 and 3. By this means, since transmission power of a pilot signal lowers and reception power of the pilot signal is also low, so that channel estimation accuracy also decreases.

On the other hand, as explained in embodiment 1, the number of data signal streams at each antenna increases, by increasing the transmission power ratio of a pilot signal to a data signal, it is possible to improve channel estimation accuracy of a pilot signal and improve a BLER characteristic of a data signal.

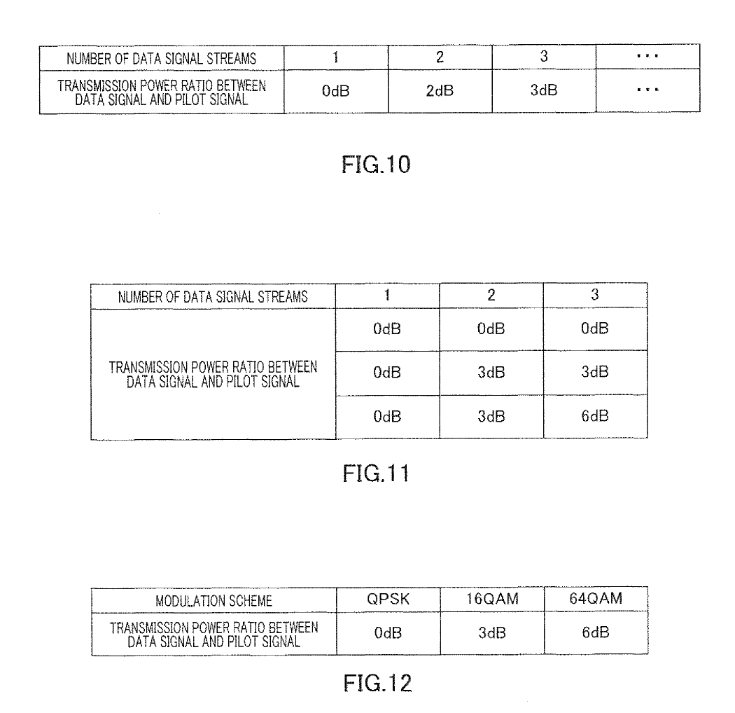

In a system where data transmission is single carrier transmission, as the number of data signal streams at each antenna increases, transmission power estimation section 111 and transmission power control section 205 according to embodiment 2 of the present invention make the increase amount of the transmission power ratio of a pilot signal to a data signal smaller. For example, as shown in FIG. 10, when the numbers of data signal streams in an antenna are 1, 2, 3, . . . , the transmission power ratios of data signals to pilot signals are 0 dB, 2 dB, 3 dB, . . . , respectively. By this means, as the number of streams increases, the increase amount of the transmission power ratio lessens. Thus, assume that the increase amount of the transmission power ratio is 2 dB (the increase amount: large) in the numbers of streams 1 to 2, and the increase amount of the transmission power ratio is 1 dB (the increase amount: small) in the numbers of streams 2 to 3.

According to embodiment 2, by lessening the increase amount of the transmission power ratio of a pilot signal to a data signal at each antenna as the number of data signal streams at each antenna increases, it is possible to improve the possibility to amplify a pilot signal in a linear region and suppress distortion of a pilot signal at a transmitter. As a result, at a receiver, it is possible to improve channel estimation accuracy by a pilot signal and improve a BLER characteristic of a data signal.

Although the present embodiment assumes single carrier transmission, it is equally possible to use multicarrier transmission. As the number of carriers of multicarrier increases, the values of the above P2-P1 and P3-P2 become smaller and the effect is weakened, but it is possible to maintain the improvement effect by the above implementation. For example, in multicarrier transmission using two carriers, when the numbers of data signal streams are 1, 2, and 3, the transmission power ratios are 0 dB, 1 dB, and 1.5 dB respectively.

Also, in the present embodiment, even if there is a room for transmission power of a data signal or pilot signal to reach to a non-linear region, as the number of data signal streams increases, the transmission power ratio of a pilot signal to a data signal increases. Suppressing interference to neighboring cells by controlling transmission power of a pilot signal according to transmission on power of a data signal, it is possible to improve channel estimation accuracy of a pilot signal.

### Embodiment 3

As described in embodiment 1, when transmission power of a pilot signal is larger than transmission power of a data signal, a pilot signal gives larger interference to other cells than a data signal, so that other-cell interference by a pilot signal may enlarge. As a result, the interference to other cells by a pilot signal increases, so that reception quality in other cells lowers.

Therefore, embodiment 3 of the present invention will describe a method to decrease other-cell interference by a pilot signal.

Since the configuration of a base station according to embodiment 3 of the present invention is the same as the configuration of embodiment 1 shown in FIG. 3 and the only difference is the function of transmission power estimation section 111, only transmission power estimation section 111 will be explained quoting FIG. 3.

Transmission power estimation section 111 stores a plurality of relationships between the number of data signal streams at each antenna of a terminal, and the transmission power ratio of a pilot signal to a data signal at each antenna, and decides the transmission power ratio of a pilot signal to a data signal at each antenna of a terminal, based on the amount of interference to other cells and the number of data signal streams at each antenna of a terminal, the number of data signal streams output from scheduling section 110. The decided transmission power ratio is output to estimation section 109, and the information related to the decided transmission power ratio (for example, the information showing which combination shown in FIG. 11 is selected) is output to encoding section 101. The relationship between the number of data signal streams at each antenna and the transmission power ratio of a pilot signal to a data signal at each antenna is known at both base station 100 and terminal 200.

Since the configuration of a terminal according to embodiment 3 of the present invention is the same as the configuration of embodiment 1 shown in FIG. 4 and the only difference is the function of transmission power control section 205, only transmission power control section 205 will be explained quoting FIG. 4.

Transmission power control section 205 stores a plurality of relationships between the number of data signal streams at each of antennas 201-1 and 201-2 of terminal 200, and the transmission power ratio of a pilot signal to a data signal at each of antennas 201-1 and 201-2, and decides the transmission power ratio of a pilot signal to a data signal, based on the information related to the transmission power ratio, and the information of the number of data signal streams at each antenna, the information output from decoding section 204. Based on the decided transmission power ratio, transmission power control section 205 controls transmission power of a pilot signal and outputs the result to multiplexing section 210. The relationship between the number of data signal streams at each of antennas 201-1 and 201-2 and the transmission power ratio of a pilot signal to a data signal at each of antennas 201-1 and 201-2 is known at both base station 100 and terminal 200.

Next, the following will describe the relationship between the number of data signal streams at each antenna of terminal 200 and the transmission power ratio of a pilot signal to a data signal at each antenna, which is the information the above-described transmission power estimation section 111 and transmission power control section 205 store.

For example, as shown in FIG. 11, transmission power estimation section 111 and transmission power control section 205 prepare three kinds of combinations of transmission power ratios of data signals to pilot signals, corresponding to the numbers of streams 1, 2, and 3 or more respectively. Specifically, the three sets of combinations are prepared: [0, 0, 0] (in the order of the numbers of streams 1 to 3) dB which does not increase the transmission power ratio of a pilot signal to a data signal regardless of the number of data signal streams; and [0, 3, 3] dB and [0, 3, 6] dB which change the transmission power ratio of a pilot signal to a data signal according to the number of data signal streams.

Base station 100 selects one of combinations based on the amount of interference to other cells. For example, base station 100 selects the combination of transmission power ratio [0, 0, 0] dB when the interference to other cells is large, and selects the combination of transmission power ratio [0, 3, 6] dB when the interference to other cells is small. The selected combination is reported to each terminal by signaling.

In this way, according to embodiment 3, by preparing a plurality of transmission power ratios of data signals to pilot signals and using one of the transmission power ratios based on the amount of interference to other cells, it is possible to decrease the transmission power of a pilot signal and decrease interference to other cells when interference to other cells is large, and it is possible to increase the transmission power of a pilot signal, improve channel estimation accuracy of the terminal, and improve a BLER characteristic of a data signal, when interference to other cells is small.

Although the present embodiment describes preparing the three sets of transmission power ratios of pilot signals to data signals, it is equally possible to prepare two sets of transmission power ratios. Specifically, assuming that the transmission power ratio of a pilot signal to a data signal is [0, 0, 0] dB or [0, 3, 6] dB, it is equally possible to select whether or not to increase the transmission power. For example, two cases are prepared: a case not to increase the transmission power ratio (0 dB) of a data signal and pilot signal regardless of the number of data signal streams; and a case to increase the transmission power ratio of a pilot signal to a data signal as the number of data signal streams increases. Based on the amount of the interference to other cells, a base station reports by signaling, to terminals, which to use.

### Embodiment 4

Since the configuration of a base station according to embodiment 4 of the present invention is the same as the configuration of embodiment 1 shown in FIG. 3 and the only difference is the function of transmission power estimation section 111, only transmission power estimation section 111 will be explained quoting FIG. 3. Also, since the configuration of a terminal according to embodiment 4 of the present invention is the same as the configuration of embodiment 1 shown in FIG. 4 and the only difference is the function of transmission power control section 205, only transmission power control section 205 will be explained quoting FIG. 4.

Transmission power estimation section 111 and transmission power control section 205, according to embodiment 4 of the present invention, increase the transmission power ratio of a pilot signal to a data signal at each antenna, as a modulation scheme (for example, 16 QAM and 64 QAM) has a larger number of bits per 1 symbol. For example, as shown in FIG. 12, when modulation schemes are QPSK, 16QAM, 64QAM, . . . , the transmission power ratios of data signals to pilot signals are 0 dB, 3 dB, 6 dB, and . . . , respectively.

According to embodiment 4, by increasing the transmission power ratio of a pilot signal to a data signal at each antenna, a modulation scheme having a larger numbers of bits per 1 symbol can improve channel estimation accuracy, so that it is possible to improve a BLER characteristic of a data signal. Also, by providing the transmission power ratio in advance, there is no need to control a data signal and a pilot signal individually, so that it is possible to prevent the amount of signaling from increasing.

Although the above embodiments describe changing the transmission power ratio according to the number of data signal streams at each antenna, it is equally possible to change the transmission power ratio according to the difference between the numbers of streams of a data signal and pilot signal at each antenna, or the presence or absence of precoding of a data signal and pilot signal.

Also, although the above embodiments describe for example the number of streams of data signals “at each antenna (which are transmitted from each antenna),” it is equally possible to describe for example the number of streams of data signals “which are input to transmission power and weight control section 211. Also, although the above embodiments describe “each antenna,” it is equally possible to decide “a certain antenna” as a reference.

Also, although the above embodiments describe a case to increase the transmission power of a pilot signal, conversely, it is equally possible to decrease the transmission power of a data signal corresponding to a pilot signal.

Also, although the above embodiments decide the transmission power ratio based on peak power (PAPR) with respect to the average power of data signals, it is equally possible to decide the transmission power ratio based on cubic metric (CM).

Also, although the above embodiments assume that the average transmission power of pilot signals is larger than the average transmission power of data signals, the average transmission power of pilot signals may be equal to or lower than the average transmission power of data signals. For example, even if the average transmission power of pilot signals is smaller than the average transmission power of data signals, a case may occur where the peak power of a pilot signal is larger than the peak power of a data signal.

Each embodiment mentioned above explains an example when the present invention is performed by hardware, but the present invention can be implemented with software.

Furthermore, each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be regenerated is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2009-145534, filed on Jun. 18, 2009, including the specification, drawings and abstract, is incorporated herein by reference in its entirety.

### INDUSTRIAL APPLICABILITY

It is possible to apply a radio transmission apparatus and transmission power control method of the present invention to, for example, a mobile communication system.

### REFERENCE SIGNS LIST

101, 207 Encoding section
102, 208 Modulation section
103, 212-1, 212-2 RF transmission section
104-1, 104-2, 201-1, 201-2 Antenna
105-1, 105-2, 202 RF reception section
106 Demultiplexing section
107, 112 DFT section
108, 113 Demapping section
109 Estimation section
110 Scheduling section
111 Transmission power estimation section
114 Signal demultiplexing section
115 IFFT section
116, 203 Demodulation section
117, 204 Decoding section
118 Error detection section
205 Transmission power control section
206 CRC section
209 Assignment section
210 Multiplexing section
211 Transmission power and weight control section

1. A radio transmission apparatus comprising:
one or more antennas;
a transmission power control section that increases a transmission power ratio of a pilot signal to a data signal transmitted from each of the antennas, in response to an increase in a number of streams of the data signal transmitted from each of the antennas; and
a transmission section that transmits the data signal and the pilot signal for which transmission power is controlled.

2. The radio transmission apparatus according to claim 1, wherein, when the data signal is transmitted in single carrier transmission, in response to an increase in the number of streams of the data signal transmitted from each of the antennas, the transmission power control section lessens an increase amount of the transmission power ratio of the pilot signal to the data signal transmitted from each of the antennas.

3. The radio transmission apparatus according to claim 1, wherein, when the number of streams of the data signal transmitted from each of the antennas is equal to or greater than a predetermined value, the transmission power control section fixes the transmission power ratio of the pilot signal to the data signal transmitted from each of the antenna.

4. The radio transmission apparatus according to claim 1, wherein the transmission power control section controls an increase amount of the transmission power ratio based on an amount of interference to other cells.

5. The radio transmission apparatus according to claim 4, wherein the transmission power control section controls whether or not to increase the transmission power ratio based on the amount of interference to other cells.

6. A transmission power control method for increasing a transmission power ratio of a pilot signal to a data signal transmitted from one or more antennas, in response to an increase in a number of streams of the data signal transmitted from each of the antennas.
